(19) United States
(12) Patent Application Publication
(10) Pub. No.: US 2015/0379439 A1
(43) Pub. Date: Dec. 31, 2015

(54) INTEGRATED AND INTRINSIC INTELLECTUAL PROPERTY MANAGEMENT

(71) Applicants: UDO KLEIN, EGGENSTEIN-LEOPOLDSHAFEN (DE); JOCHEN MAYERLE, FLEIN (DE)

(72) Inventors: UDO KLEIN, EGGENSTEIN-LEOPOLDSHAFEN (DE); JOCHEN MAYERLE, FLEIN (DE)

(21) Appl. No.: 14/318,693

(22) Filed: Jun. 30, 2014

(51) Int. Cl. G06Q 10/06

(52) U.S. Cl. CPC G06Q 10/06

(57) ABSTRACT

A software product is to be changed from one state to another of a lifecycle process of the software product. The request to change the software product is received at a transport and lifecycle management tool to be processed. The software product includes one or more deployable units. A deployable unit of the one or more deployable units includes or associated with an instance of a transportable object of type. In one aspect, upon changing the software product the instance of the transportable object of type IP is changed according to the changed deployable unit.

### BACKGROUND

Software products are not only collection of machine readable and executable content, but may also be compilations of knowledge, ideas and other intellectual assets or capital. These intellectual assets are subject to intellectual property laws or other regulations of that kind. Determining intellectual property content within software products is valuable knowledge for patent lawsuits, valuation of software enterprises, licensing and cross-licensing opportunities, mergers and acquisitions, etc. The currently employed techniques entail tracking patents, licenses, and other IP assets within a database. Such databases may contain relevant IP assets for various software products but may also be employed for other industries such as pharmaceuticals, mechanics, etc.

### BRIEF DESCRIPTION OF THE DRAWINGS

The claims set forth the embodiments with particularity. The embodiments are illustrated by way of examples and not by way of limitation in the figures of the accompanying drawings in which like references indicate similar elements. The embodiments, together with its advantages, may be best understood from the following detailed description taken in conjunction with the accompanying drawings.

FIG. 1 illustrates an exemplary computer system to track IP throughout a software product lifecycle, according to one embodiment.

FIG. 2 illustrates a process to track IP throughout a software product lifecycle, according to one embodiment.

FIG. 3 illustrates a process to deploy IP along with deployment of a computer application implementing the IP, according to one embodiment.

FIG. 4 illustrates a process to determine IP content associated with a software product, according to one embodiment.

FIG. 5 illustrates an exemplary computer system, according to one embodiment.

### DETAILED DESCRIPTION

Embodiments of techniques for hybrid applications operating between on-premise and cloud platforms are described herein. In the following description, numerous specific details are set forth to provide a thorough understanding of the embodiments. One skilled in the relevant art will recognize, however, that the embodiments can be practiced without one or more of the specific details, or with other methods, components, materials, etc. In other instances, well-known structures, materials, or operations are not shown or described in detail.

Reference throughout this specification to “one embodiment”, “this embodiment” and similar phrases, means that a particular feature, structure, or characteristic described in connection with the embodiment is included in at least one of the one or more embodiments. Thus, the appearances of these phrases in various places throughout this specification are not necessarily all referring to the same embodiment. Furthermore, the particular features, structures, or characteristics may be combined in any suitable manner in one or more embodiments.

The process of determining and identifying IP content within software products requires expertise and manual effort. Determining the IP content may be difficult as intangible intellectual assets may not be easily associated with or mapped to software products and executable entities contained thereof. For example, an idea may be implementation of concise and identifiable algorithm or a specific interface. Another example may be a set of table entries that represents a workflow for an optimized process. Yet another example of idea may be an implementation of non-functional requirement in a distributed and orchestrated way, where the implementation may be scattered within a large number of lines of codes in different parts of the software product. Mapping expressions or implementation of ideas to patents or other IP assets is non-trivial in the software industry.

A known approach for identification of patents, trade secrets, trademarks, copyrights, licenses, and other IP assets is by tracking the IP assets in a database, for example, in an IP management docketing system. Those databases or docketing systems store and organize the IP assets but the IP assets are not linked with an actual implementation or expression of the subject matter covered by the relevant IP assets. For example, software products and, in particular source code portions thereof, are not technically linked to or associated with the IP assets. Systems managing versioning of software products or other transport and lifecycle management tools do not have connection with respective docketing systems and the tracked IP assets within.

In one embodiment, a link or a hook is established between an IP asset and a software product or system. In particular, a link may be established between an IP asset and an executable entity within the software product such as a package including application binaries. In one embodiment, the link or the hook may be a transportable object of type IP. Technically, transportable objects of various types may be associated with software products or systems. Examples of transportable objects include, but are not limited to, Packages, Executable code. Source Code, Documentation, Classes, Domain definitions, Data element Definitions, Screens, Functions Groups, Groups, Tables, Authorization Objects, Interfaces, Text Elements, Roles, Views, Business Configuration, Configuration Schemas, Calendar entries, Predefined Queries, Matchcodes, Annotations, Parameters, Test Cases, Test Data.

The transportable object of type IP represents a technical representation of IP assets or other types of intellectual capital, where that representation is integrated into the relevant software systems or products representing actual implementation of the respective IP assets or intellectual capital. A transportable object including transportable objects of type IP may be any entity that can be described by metadata of transport and lifecycle management tools, etc. In one embodiment, transportable objects of type IP may be used to track IP throughout lifecycle of software products, which represent implementation or expression of the subject matter covered by the respective IP.

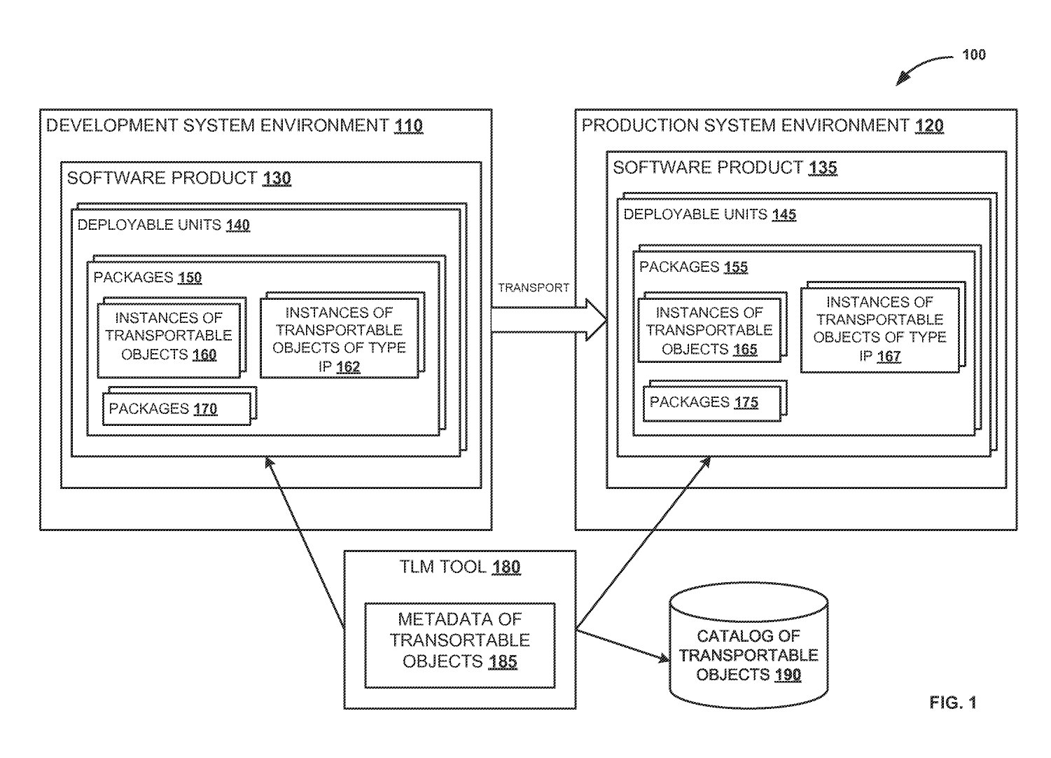

FIG. 1 illustrates an exemplary computer system 100 to track IP throughout a software product lifecycle, according to one embodiment. Technically, a software product may include a number of deployable units. For example, software product 130 may consist of a number of deployable units 140. These deployable units may be structured in packages, which in turn may further include more small-grained packages. For example, deployable units 140 may include packages 150, which in turn may include packages 170. Similarly, according to terminology adopted in Eclipse® projects, software products may be structured into features, where each feature may correspond to a particular functionality of the software product and may group a number of plug-ins to be managed as a single entity. A plug-in in Eclipse® is the basic installable and executable unit. Both a feature and a plug-in may be represented as a package. Examples of packages that may be included into deployable units include, but are not limited to, Java archive file (JAR), enterprise archive file (EAR), web archive file (WAR), etc. The packages of software products may include one or more transportable objects. For example, software product 130 may include a number of instances of transportable objects 160 and a number of instances of transportable objects of type IP 162.

Transport and lifecycle management tools (e.g., transport and lifecycle management (TLM) tool 180) automate, among others, software systems and products transportation from one system environment to another, software provisioning, installation, patching, upgrade, configuration, etc. In one embodiment, TLM tools keep metadata describing transportable objects. For example, TLM tool 180 may use metadata of transportable objects 185 to keep track of types of transportable objects that may be transported by TLM tool 180. Table 1 below represents an exemplary metadata describing a transportable object of type IP. Table 1 includes a number of attributes that a transportable object of type IP may have and respective description of the attributes.

TABLE 1
Metadata for transportable object of type IP

Title: Title of the patent.
Package: Package assignment of the patent.
Usage: List of implementation entities which rely on the patent
Authorizations: The preferred access rights for IP material.
Creator: Primary creators of the patent.
Assignee: The person or corporation that legally owns the patent
Patent Number: The complete identifying number attached to the patent.
Digital Object Identifier (DOI): The complete identifying number
attached to the patent.
Abstract: Abstract of the patent.
Subject Keywords: Subject headings and related keywords that will help
the user find the patent and relate it to other TLM entities.
Source: Own patent, by acquisition from 3rd party through license
agreement.
Validity: Validity of 3rd party license and validity of own rights.
License coverage: Only for 3rd party patents: What kind of usage of IP
is permitted by 3rd party license agreement.
Publisher: Publisher information related to the patent including contact
information, if applicable.
Date Created: The date the patent was granted.
Language: The language of the original item.
Country Coverage: coverage of patent, e.g. USPTO, others . . .

A number of instances of the transportable object of type IP may be created and associated with packages 150 or other executable entities of software product 130. Further, TLM tool 180 may store associations of one or more packages from packages 150 to corresponding one or more transportable objects from transportable objects 160 or 162. An association of a package of a deployable unit with respective transportable object may be kept as a table entry in catalog of transportable objects 190.

Software product 130 may be deployed to and installed on development system environment 110. At one point in time, software product 130 may be shipped to customers and moved from development system environment 110 to another system environment, for example, dedicated to software at productive stage of their lifecycle. In one embodiment, a request to transport software product 130 from development system environment 110 to production system environment 120 may be received at TLM tool 180. Software product 135 represents software product 135 transported and deployed to production system environment 120. Similarly, packages 155 represent packages 150; packages 175 represents packages 170; instances of transportable objects 165 represent instances of transportable objects 160; and instances of transportable objects of type IP 167 represent instances of transportable objects of type IP 162 transported from development system environment 110 to production system environment 120.

In one embodiment, TLM tool 180 transports instances of transportable objects of type IP 162 along with transportation or deployment of deployable units 140. Upon transportation of deployment units 140 together with the instances of the transportable objects of type IP 162, associations between the deployable units 145 and corresponding instances of transportable objects of type IP 167 may be stored in catalog of transportable objects 190. Thus, instances of transportable objects are tracked upon upgrade, update, transportation, etc., of software products to keep track of IP throughout the lifecycle of the software products.

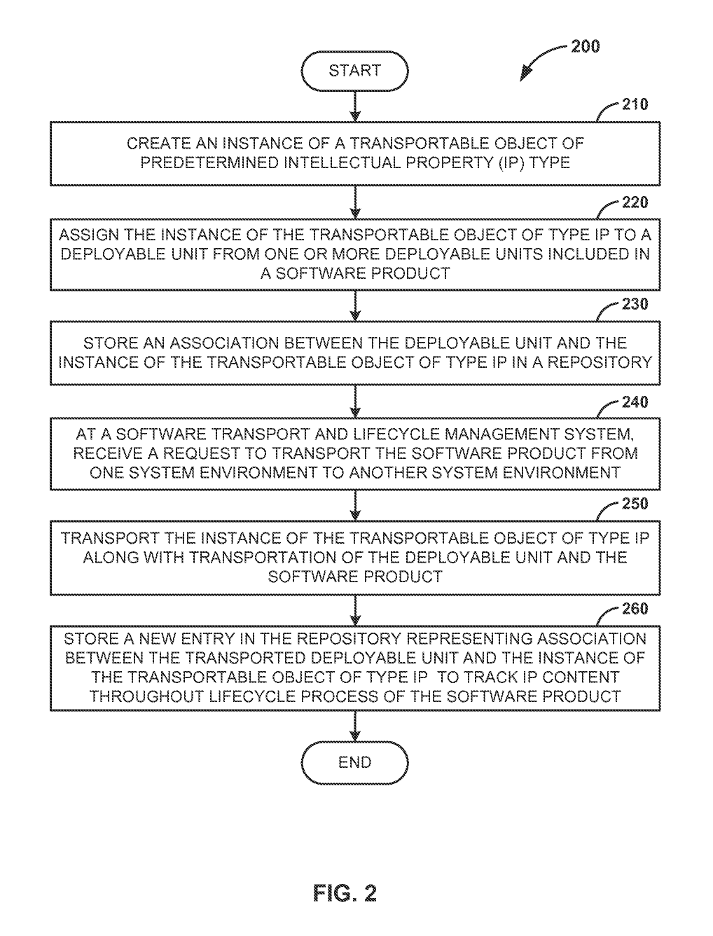

FIG. 2 illustrates process 200 to track IP throughout a software product lifecycle, according to one embodiment. At 210, an instance of a transportable object of a predetermined IP type is created. In one embodiment, the instance of the transportable object of type IP may be created at a software development stage of a software product. In other embodiments, instances of transportable objects of type IP may be created retroactively for software products already developed and provisioned.

Once created, at 220, the instance of the transportable object of type IP is assigned to a deployable unit from one or more deployable units included in a software product. In particular, the instance of the transportable object may be assigned to a package included in the deployable unit. For example, an instance of transportable object of type IP that may represent an invention disclosure may be assigned to respective packages or executable entities, which cover the subject matter described in the invention disclosure. At 230, an association of the deployable unit and the instance of the transportable object of type IP may be stored in a repository. For example, a new entry in the catalog of transportable objects 190 in FIG. 1 may represent the association between the deployable unit and the instance of the transportable object. At 240, a request to transport the software product from one system environment to another system environment is received at a software transport and lifecycle management system. In response to the request, at 250, the instance of the transportable object of type IP may be transported along with transportation of the deployable unit and the software product. At 260, a new entry is stored in a repository. The new entry represents an association between the transported deployable unit and the instance of the transportable object of type IP. The association between the transportable objet of type IP and the deployable unit or package thereof is stored to track IP content throughout transportation or other change in lifecycle process of the software product.

In various embodiments, the software product may undergo various changes from one state of the lifecycle process to another. For example, changing the state of the software product from one state of the lifecycle process to another may include transporting the software product from one system environment to another, updating, upgrading, shipping, patching, or other transformation of the software product. Upon changing the software product from a first state to a second state of the lifecycle process, the instance of the transportable object of type IP is changed accordingly. Further, the change is tracked by storing an association between the instance of the transportable object of type IP and the corresponding changed deployable unit to which the instance of the transportable object of type IP is assigned. For example, a value of the package assignment attribute may be changed. Thus, when the software product is updated, upgraded, shipped, patched or undergoes other change in the lifecycle process, the instance of the transportable object of type IP being technically linked to the software product undergoes the respective change along with the software product. Thus, IP content or assets may be represented in and be tracked throughout various software lifecycle process chains.

In various embodiments, not only transportable objects but also other types of objects, technical representations or formats may be used to represent IP entities that can be linked to executable entities of software systems and products. Those objects, technical representations, files or formats representing IP may be referenced and used by software versioning control systems, software delivery systems, deployment systems, etc. Thus, in one aspect, IP may be represented and may be an object included in the bill of materials of a software product.

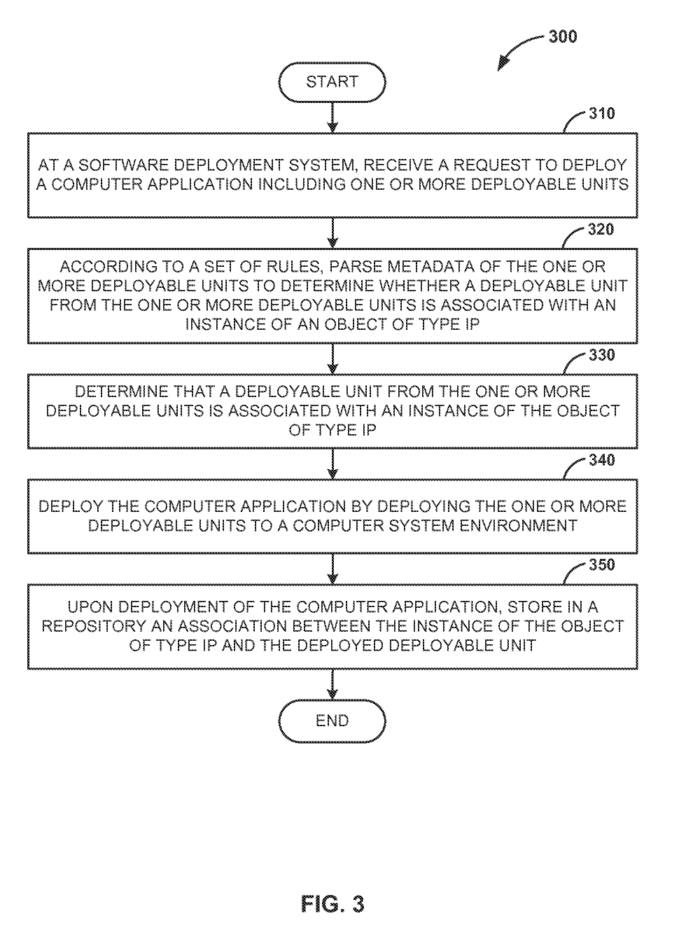

FIG. 3 illustrates process 300 to deploy IP along with deployment of a computer application implementing the IP, according to one embodiment. At 310, a request is received at a software deployment system to deploy a computer application including one or more deployable units. At 320, metadata of the one or more deployable units is parsed according to a set of rules. For example, the set of rules may include instructions to identify IP content. Metadata of the one or more deployable units is parsed to determine whether a deployable unit from the one or more deployable units is associated with an instance of an object of type IP, for example, whether the deployable unit references a file or other technical format representing IP content. At 330, it is determined that a deployable unit from the one or more deployable units is associated with an instance of the object of type IP. At 340, the computer application is deployed to a computer system environment by deploying the one or more deployable units. For example, the computer application may be deployed to a cloud computer platform to be accessed over the Internet. Upon deployment of the computer application, at 350, an association between the instance of the object of type IP and the deployed deployable unit is stored in a repository. The association is stored in a repository to track IP along with deployment of the computer application.

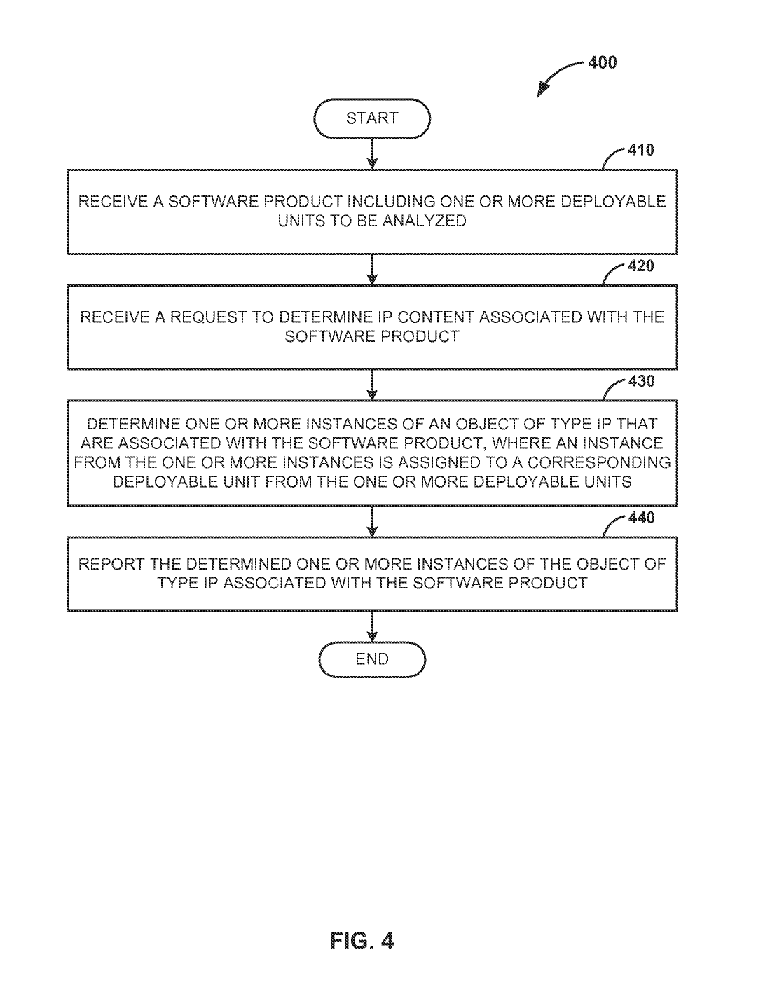

FIG. 4 illustrates process 400 to determine IP content associated with a software product, according to one embodiment. At 410, a software product including one or more deployable units is received to be analyzed. At 420, a request to determine IP content associated with the software product is received. At 430, one or more instances of an object of type IP that are associated with the software product are determined, where an instance from the one or more instances is assigned to a corresponding deployable unit from the one or more deployable units. For example, a repository such as catalog of transportable objects 190 in FIG. 1 that stores associations between deployable units and instances of the object of type IP may be queried to determine instances of the object of type IP that are associated with packages and deployable units of the software product. At 440, the determined one or more instances of the object of type IP are reported to be associated with the software product.

Some embodiments may include the above-described methods being written as one or more software components. These components, and the functionality associated with each, may be used by client, server, distributed, or peer computer systems. These components may be written in a computer language corresponding to one or more programming languages such as, functional, declarative, procedural, object-oriented, lower level languages and the like. They may be linked to other components via various application programming interfaces and then compiled into one complete application for a server or a client. Alternatively, the components maybe implemented in server and client applications. Further, these components may be linked together via various distributed programming protocols. Some example embodiments may include remote procedure calls being used to implement one or more of these components across a distributed programming environment. For example, a logic level may reside on a first computer system that is remotely located from a second computer system containing an interface level (e.g., a graphical user interface). These first and second computer systems can be configured in a server-client, peer-to-peer, or some other configuration. The clients can vary in complexity from mobile and handheld devices, to thin clients and on to thick clients or even other servers.

The above-illustrated software components are tangibly stored on a computer readable storage medium as instructions. The term “computer readable storage medium” should be taken to include a single medium or multiple media that stores one or more sets of instructions. The term “computer readable storage medium” should be taken to include any physical article that is capable of undergoing a set of physical changes to physically store, encode, or otherwise carry a set of instructions for execution by a computer system which causes the computer system to perform any of the methods or process steps described, represented, or illustrated herein. A computer readable storage medium may be a non-transitory computer readable storage medium. Examples of a non-transitory computer readable storage media include, but are not limited to: magnetic media, such as hard disks, floppy disks, and magnetic tape; optical media such as CD-ROMs, DVDs and holographic devices; magneto-optical media; and hardware devices that are specially configured to store and execute, such as application-specific integrated circuits (“ASICs”), programmable logic devices (“PLDs”) and ROM and RAM devices. Examples of computer readable instructions include machine code, such as produced by a compiler, and files containing higher-level code that are executed by a computer using an interpreter. For example, an embodiment may be implemented using Java, C++, or other object-oriented programming language and development tools. Another embodiment may be implemented in hard-wired circuitry in place of, or in combination with machine readable software instructions.

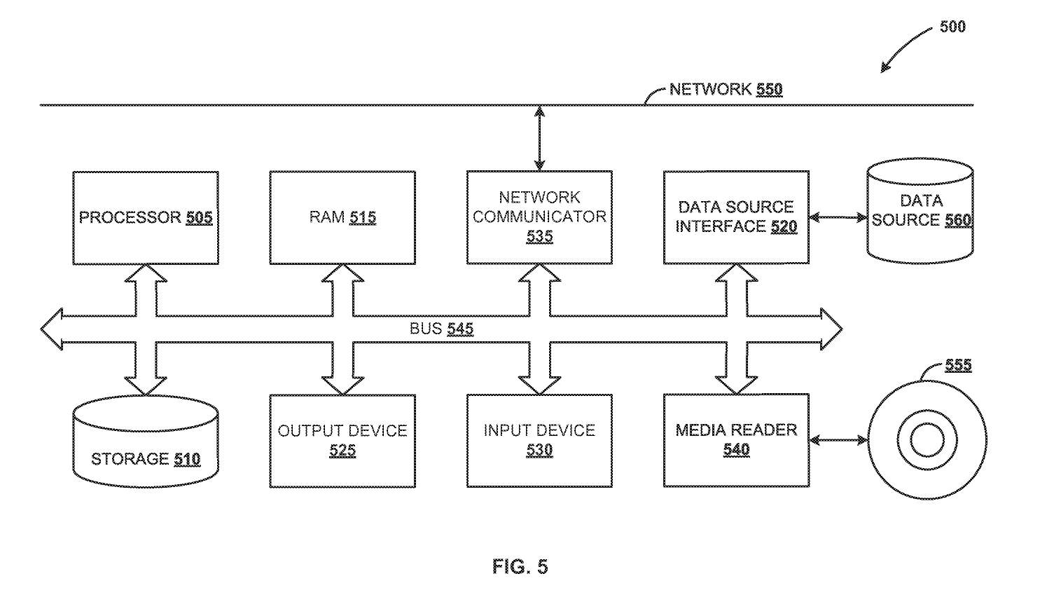

FIG. 5 is a block diagram of an exemplary computer system 500. The computer system 500 includes a processor 505 that executes software instructions or code stored on a computer readable storage medium 555 to perform the above-illustrated methods. The processor 505 can include a plurality of cores. The computer system 500 includes a media reader 540 to read the instructions from the computer readable storage medium 555 and store the instructions in storage 510 or in random access memory (RAM) 515. The storage 510 provides a large space for keeping static data where at least some instructions could be stored for later execution. According to some embodiments, such as some in-memory computing system embodiments, the RAM 515 can have sufficient storage capacity to store much of the data required for processing in the RAM 515 instead of in the storage 510. In some embodiments, all of the data required for processing may be stored in the RAM 515. The stored instructions may be further compiled to generate other representations of the instructions and dynamically stored in the RAM 515. The processor 505 reads instructions from the RAM 515 and performs actions as instructed. According to one embodiment, the computer system 500 further includes an output device 525 (e.g., a display) to provide at least some of the results of the execution as output including, but not limited to, visual information to users and an input device 530 to provide a user or another device with means for entering data and/or otherwise interact with the computer system 500. Each of these output devices 525 and input devices 530 could be joined by one or more additional peripherals to further expand the capabilities of the computer system 500. A network communicator 535 may be provided to connect the computer system 500 to a network 550 and in turn to other devices connected to the network 550 including other clients, servers, data stores, and interfaces, for instance. The modules of the computer system 500 are interconnected via a bus 545. Computer system 500 includes a data source interface 520 to access data source 560. The data source 560 can be accessed via one or more abstraction layers implemented in hardware or software. For example, the data source 560 may be accessed by network 550. In some embodiments the data source 560 may be accessed via an abstraction layer, such as, a semantic layer.

A data source is an information resource. Data sources include sources of data that enable data storage and retrieval. Data sources may include databases, such as, relational, transactional, hierarchical, multi-dimensional (e.g., OLAP), object oriented databases, and the like. Further data sources include tabular data (e.g., spreadsheets, delimited text files), data tagged with a markup language (e.g., XML data), transactional data, unstructured data (e.g., text files, screen scrapings), hierarchical data (e.g., data in a file system, XML data), files, a plurality of reports, and any other data source accessible through an established protocol, such as, Open Data Base Connectivity (ODBC), produced by an underlying software system (e.g., ERP system), and the like. Data sources may also include a data source where the data is not tangibly stored or otherwise ephemeral such as data streams, broadcast data, and the like. These data sources can include associated data foundations, semantic layers, management systems, security systems and so on.

In the above description, numerous specific details are set forth to provide a thorough understanding of embodiments. One skilled in the relevant art will recognize, however that the embodiments can be practiced without one or more of the specific details or with other methods, components, techniques, etc. In other instances, well-known operations or structures are not shown or described in details.

Although the processes illustrated and described herein include series of steps, it will be appreciated that the different embodiments are not limited by the illustrated ordering of steps, as some steps may occur in different orders, some concurrently with other steps apart from that shown and described herein. In addition, not all illustrated steps may be required to implement a methodology in accordance with the one or more embodiments. Moreover, it will be appreciated that the processes may be implemented in association with the apparatus and systems illustrated and described herein as well as in association with other systems not illustrated.

The above descriptions and illustrations of embodiments, including what is described in the Abstract, is not intended to be exhaustive or to limit the one or more embodiments to the precise forms disclosed. While specific embodiments and examples are described herein for illustrative purposes, various equivalent modifications are possible, as those skilled in the relevant art will recognize. These modifications can be made in light of the above detailed description. Rather, the scope is to be determined by the following claims, which are to be interpreted in accordance with established doctrines of claim construction.

What is claimed is:

1. A computer implemented method to track intellectual property (IP) throughout a software product lifecycle, the method comprising:
receiving a software product including one or more deployable units, wherein an instance of a transportable object of type IP from one or more instances of the transportable object of type IP is assigned to a corresponding deployable unit from the one or more deployable units;
at a transport and lifecycle management tool, receiving a request to transport the software product;
upon receiving the request, transporting the software product from one system environment to another by transporting the one or more deployable units; and
in response to transporting the software product, transporting the instance of the transportable object of type IP along with the software product.

2. The method of claim 1 further comprising:
tracking the transportation of the instance of the transportable object of type IP by storing an association between the deployable unit that is transported along with the software product and the assigned instance of transportable object of type IP in a repository.

3. The method of claim 1, wherein transporting the instance of the transportable object of type IP along with the software product further comprises:
deploying the instance of the transportable object of type IP along with deployment of the deployment unit to which the instance transportable object of type IP is assigned.

4. The method of claim 1, wherein transporting the software product from one system environment to another further comprises:
shipping the instance of the transportable object of type IP along with the deployment unit to which the instance transportable object of type IP is assigned.

5. The method of claim 1 further comprising:
receiving a request to determine IP content associated with the software product;
determine the one or more instances of the transportable object of type IP, wherein each instance from the one or more instances is assigned to at least one deployable unit from the one or more deployable units; and
reporting the one or more instances of transportable object of type IP associated with the software product.

6. The method of claim 1 further comprising:
assigning a new instance of transportable object of type IP to a package included in a deployable unit from the one or more deployable units to ingrate IP with the software product.

7. The method of claim 1 further comprising:
changing a state of the deployable unit by changing the software product from one state to another of a lifecycle process of the software product; and
upon changing the software product from one state to another of the lifecycle process, store an association between the instance of the transportable object of type IP and the changed deployable unit.

8. A computer system to track intellectual property (IP) throughout a lifecycle process of the software product, the system comprising:
a memory to store computer executable instructions;
at least one computer processor coupled to the memory to execute the instructions, to perform operations comprising:
receiving a software product including one or more deployable units, wherein an instance of a transportable object of type IP from one or more instances of the transportable object of type IP is assigned to a corresponding deployable unit from the one or more deployable units;
at a transport and lifecycle management tool, receiving a request to change the software product from a first state to a second state of the lifecycle process;
upon receiving the request, changing the software product from the first state to the second state by at least changing the deployable unit to which the instance of the transportable object of type IP; and
in response to changing the software product, changing the instance of the transportable object of type IP according to the changed deployable unit.

9. The system of claim 8, wherein the operations further comprise:
tracking the changed instance of the transportable object of type IP by storing an association between the changed deployable unit and the instance of transportable object of type IP in a repository.

10. The system of claim 8, wherein the operations further comprise:
transporting the software product from one system environment to another by transporting the one or more deployable units.

11. The system of claim 8, wherein the operations further comprise:
in response to transporting the software product, transporting the instance of the transportable object of type IP along with the software product.

12. The system of claim 8, wherein the operations further comprise:
receiving a request to determine IP content associated with the software product;
determine the one or more instances of the transportable object of type IP, wherein each instance from the one or more instances is assigned to at least one deployable unit from the one or more deployable units; and
reporting the one or more instances of transportable object of type IP associated with the software product.

13. The system of claim 8, wherein the operations further comprise:
assigning a new instance of transportable object of type IP to a package included in a deployable unit from the one or more deployable units to ingrate IP with the software product.

14. A non-transitory computer readable medium storing instructions thereon, which when executed by a processor cause a computer system to:
receive a software product including one or more deployable units, wherein an instance of a transportable object of type IP from one or more instances of the transportable object of type IP is assigned to a corresponding deployable unit from the one or more deployable units;
at a transport and lifecycle management tool, receive a request to transport the software product;
upon receiving the request, transport the software product from one system environment to another by transporting the one or more deployable units; and
in response to transporting the software product, transport the instance of the transportable object of type IP along with the software product.

15. The computer readable medium of claim 14, wherein the instructions when executed by the processor cause the computer system further to:
track the transportation of the instance of the transportable object of type IP by storing an association between the deployable unit that is transported along with the software product and the assigned instance of transportable object of type IP in a repository.

16. The computer readable medium of claim 14, wherein the instructions when executed by the processor cause the computer system further to:
deploy the instance of the transportable object of type IP along with deployment of the deployment unit to which the instance transportable object of type IP is assigned.

17. The computer readable medium of claim 14, wherein the instructions when executed by the processor cause the computer system further to:
ship the instance of the transportable object of type IP along with the deployment unit to which the instance transportable object of type IP is assigned.

18. The computer readable medium of claim 14, wherein the instructions when executed by the processor cause the computer system further to:
receive a request to determine IP content associated with the software product;
determine the one or more instances of the transportable object of type IP, wherein each instance from the one or more instances is assigned to at least one deployable unit from the one or more deployable units; and
report the one or more instances of transportable object of type IP associated with the software product.

19. The computer readable medium of claim 14, wherein the instructions when executed by the processor cause the computer system further to:
assigning a new instance of transportable object of type IP to a package included in a deployable unit from the one or more deployable units to ingrate IP with the software product.

20. The computer readable medium of claim 14, wherein the instructions when executed by the processor cause the computer system further to:
change a state of the deployable unit by changing the software product from one state to another of a lifecycle process of the software product; and
upon changing the software product from one state to another of the lifecycle process, store an association between the instance of the transportable object of type IP and the changed deployable unit.
